(19) United States
(12) Patent Application Publication
(10) Pub. No.: US 2011/0102909 A1
(43) Pub. Date: May 5, 2011

(54) LENS BARREL AND DIGITAL CAMERA INCLUDING THE SAME

(75) Inventors: Hee-yun Chung, Busan (KR); Sang-whan Oh, Suwon-si (KR)

(73) Assignee: Samsung Electronics Co., Ltd., Suwon-si (KR)

(21) Appl. No.: 12/915,413

(22) Filed: Oct. 29, 2010

(30) Foreign Application Priority Data
Oct. 30, 2009 (KR) 10-2009-0104209

(51) Int. Cl. G02B 7/10

(52) U.S. Cl. 359/697; 359/700

(57) ABSTRACT

A lens barrel includes a barrel case comprising a fixed barrel mounted to a camera body and a first movement barrel that is moveable along an optical axis according to a cam groove formed on an inner surface of the fixed barrel; and a lens assembly accommodated in the barrel case, wherein a tele section is a front portion of the cam groove and is oblique with respect to a rotational direction of the first movement barrel by a predetermined angle, wherein a front side is a side in a direction toward a subject.

### CROSS-REFERENCE TO RELATED PATENT APPLICATION

This application claims the benefit of Korean Patent Application No. 10-2009-0104209, filed on Oct. 30, 2009, in the Korean Intellectual Property Office, the disclosure of which is incorporated herein in its entirety by reference.

### BACKGROUND

The invention relates to a lens barrel and a digital camera including the lens barrel, and more particularly, to a lens barrel in which precision in positioning an optical lens is increased, and a digital camera including the lens barrel.

In general, a camera includes a lens barrel and a camera main body. The lens barrel is mounted in front of the camera main body, and includes an optical lens for forming a subject image and a movement barrel for accommodating the optical lens. The movement barrel may be driven in an optical axis direction, and in connection to the driving of the movement barrel, the optical lens performs a zooming operation for adjusting a magnification of the subject image and a focusing operation for adjusting a focal point of the optical lens.

The zooming and focusing operations are performed by controlling a rotational amount of the movement barrel related to driving of the optical lens. More specifically, the zooming and focusing operations may be performed by detecting a current rotation position of the movement barrel and then controlling the rotational amount based thereon. However, according to the conventional art, the detected current rotation position may be wrong and thus the zooming and focusing operations are controlled based on the incorrectly detected rotation positions of the movement barrel. Accordingly, the optical lens may not be moved exactly to a target position and precision in positioning the optical lens is decreased.

### SUMMARY

The invention provides a lens barrel in which precision in positioning an optical lens is increased, and a digital camera including the lens barrel.

According to an embodiment of the invention, there is provided a lens barrel comprising: a barrel case comprising a fixed barrel mounted to a camera body and a first movement barrel that is moveable along an optical axis according to a cam groove formed on an inner surface of the fixed barrel; and a lens assembly accommodated in the barrel case, wherein a tele section is a front portion of the cam groove and is oblique with respect to a rotational direction of the first movement barrel by a predetermined angle, wherein a front side is a side in a direction toward a subject.

An optical axis direction position sensor for detecting a position of the first movement barrel along the optical axis may be disposed on the fixed barrel.

When the cam groove is developed on a plane, the cam groove may comprise: the tele section in the front portion of the cam groove, a wide section that extends from the tele section along an oblique line, and a close section that extends from the wide section and is parallel to the rotational direction of the first movement barrel.

The tele section may comprise two ends referred to as first and second positions, respectively, wherein the first position contacts the wide section and is closer to the front side than the second position, which is away from the wide section.

The lens barrel may comprise a straight guide member that is movable with the first movement barrel along the optical axis is disposed on an inner portion of the first movement barrel. An optical axis direction position sensor for detecting a position of the straight guide member along the optical axis may be disposed on the fixed barrel.

The lens barrel may further comprise a second movement barrel that is disposed inside the straight guide member, wherein the second movement barrel is movable along the optical axis according to a cam groove in the straight guide member.

The lens barrel may further comprise a driving element that provides rotational power to the first movement barrel, wherein a rotation position sensor for detecting a rotational state of the driving element is disposed near the driving element, and a protrusion that is coupled to the cam groove may be formed on an outer circumference of the first movement barrel.

According to another aspect of the present invention, there is provided a digital camera comprising: a camera body; a barrel case comprising a fixed barrel mounted to a camera body and a first movement barrel that is movable along an optical axis according to a cam groove formed on the fixed barrel; and a lens assembly accommodated in the barrel case, wherein a tele section is a front portion of the cam groove and is oblique with respect to a rotational direction of the first movement barrel by a predetermined angle, wherein a front side is a side in a direction toward a subject.

An optical axis direction position sensor for detecting a position of the first movement barrel along the optical axis may be disposed on the fixed barrel.

When the cam groove is developed on a plane, the cam groove may comprise: the tele section in the front portion of the cam groove, a wide section that extends from the tele section along an oblique line, and a close section that extends from the wide section and is parallel to the rotational direction of the first movement barrel.

The tele section may comprise two ends referred to as first and second positions, respectively, wherein the first position contacts the wide section and is closer to the front side than the second position which is away from the wide section.

The digital camera may comprise a straight guide member that is movable with the first movement barrel along the optical axis is disposed on an inner portion of the first movement barrel. An optical axis direction position sensor for detecting a position of the straight guide member along the optical axis may be disposed on the fixed barrel.

The digital camera may further comprise a second movement barrel that is disposed inside the straight guide member, wherein the second movement barrel is movable along the optical axis according to a cam groove in the straight guide member.

The digital camera may further comprise a driving element that provides rotational power to the first movement barrel, wherein a rotation position sensor for detecting a rotational state of the driving element is disposed near the driving element.

A protrusion that is coupled to the cam groove may be formed on an outer circumference of the first movement barrel.

### BRIEF DESCRIPTION OF THE DRAWINGS

The above and other features and advantages of the invention will become more apparent by describing in detail exemplary embodiments thereof with reference to the attached drawings in which:

FIG. 1 is a cross-sectional view illustrating a lens barrel according to an embodiment of the present invention;

FIGS. 2 and 3 are side views of the lens barrel illustrated in FIG. 1, showing driving mechanisms of a first movement barrel;

FIG. 4 is a pictorial diagram illustrating an inner portion of a fixed barrel in which a cam groove is mounted and guides the first movement barrel, according to an embodiment of the present invention; and

FIG. 5 is a side view cross-sectional diagram illustrating an arrangement of sensors for position controlling of the first movement barrel.

### DETAILED DESCRIPTION

Various embodiments of the invention will now be described more fully with reference to the accompanying drawings, in which exemplary embodiments of the invention are shown.

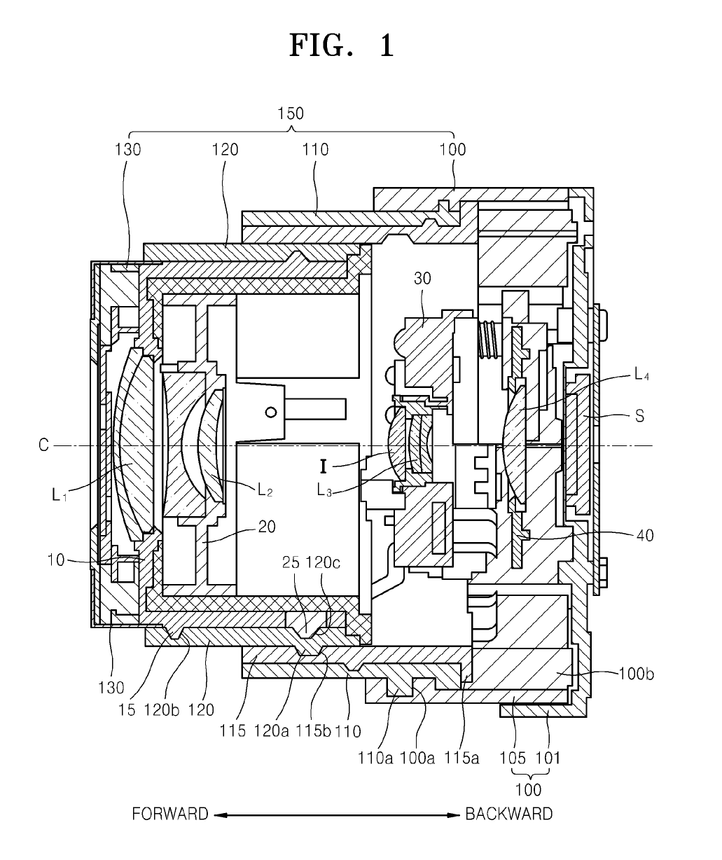

FIG. 1 is a cross-sectional view illustrating a lens barrel according to an embodiment of the present invention. The lens barrel includes a four-group zoom lens including first through fourth lens assemblies L1, L2, L3, and L4 that are disposed from a front side to a backside of the lens barrel. However, the lens barrel of the invention is not limited thereto, and may also be a three-group zoom lens including first through third lens assemblies.

In the present specification, a front side denotes a direction toward a subject side and a backside denotes a direction toward an image sensor S along an optical axis C. The first through fourth lens assemblies L1, L2, L3, and L4 are accommodated in a barrel case 150, and may move forward or backward along the optical axis C. For example, the first through third lens assemblies L1, L2, and L3 may be driven along the optical axis C to perform a zooming operation, and the fourth lens assembly L4 may be displaced finely along the optical axis C to perform a focusing operation.

The barrel case 150 includes a fixed barrel 100 that is fixedly mounted on a camera body, and first through third movement barrels 110, 120, and 130 that may be drawn from the fixed barrel 100. The fixed barrel 100 includes a lens base 101 and a guide barrel 105 that is cylinder-shaped and that is an outermost portion of the lens barrel with respect to the optical axis C.

The first movement barrel 110 may be accommodated in the fixed barrel 100, and may be rotated with respect to the fixed barrel 100 to be driven along a predetermined cam curve and along the optical axis C. A protrusion 110a is formed on an outer circumference of the first movement barrel 110, and a cam groove 100a to which the protrusion 110a may be coupled is formed on an inner circumference of the fixed barrel 100. An amount that the first movement barrel 110 may move along the optical axis C is determined according to the relationship between the protrusion 110a and the cam groove 100a. That is, as the first movement barrel 110 is rotated with respect to the fixed barrel 100 by an actuator (not shown), the protrusion 110a is moved along the cam groove 100a, and accordingly, the first movement barrel 110 is moved along the optical axis C.

A straight guide member 115 is disposed on an inner portion of the first movement barrel 110. The straight guide member 115 does not rotate but moves with the first movement barrel 110 along the optical axis C. The straight guide member 115 is coupled to the first movement barrel 110, and thus is moved with the first movement barrel 110 along the optical axis C when the first movement barrel 110 is moved along the optical axis C. A protrusion 115a that is coupled to a guide groove 100b of the fixed barrel 100 past the first movement barrel 110 is formed at a back end of the straight guide member 115. The protrusion 115a may be moved along the guide groove 100b, and accordingly, the straight guide member 115 does not rotate but moves with the first movement barrel 110 along the optical axis C.

The second movement barrel 120 is disposed on an inner portion of the straight guide member 115. The second movement barrel 120 may be moved along the optical axis C according to a predetermined cam curve formed on the straight guide member 115. A protrusion 120a is formed on an outer circumference of the second movement barrel 120, and a cam groove 115b to which the protrusion 120a may be coupled is formed on an inner circumference of the straight guide member 115. Meanwhile, an arm member (not shown) is formed on the outer circumference of the second movement barrel 120, and the arm member is coupled to a groove (not shown) of the first movement barrel 110 through the straight guide member 115. Accordingly, the second movement barrel 120 rotates with the first movement barrel 110, and also, when moved along the cam groove 115a of the straight guide member 115, the protrusion 120a of the second movement barrel 120 is moved along the optical axis C.

The third movement barrel 130 is formed on an inner portion of the second movement barrel 120. The third movement barrel 130 is moved along the optical axis C according to a predetermined cam curve formed in the second movement barrel 120. A protrusion 15 is formed on an outer circumference of the third movement barrel 130, and a cam groove 120b to which the protrusion 15 may be coupled is formed on an inner circumference of the second movement barrel 120. The first lens assembly L1 is formed on a front end of the third movement barrel 130, and the first lens assembly L1 and the third movement barrel 130 may be moved as a single body along the optical axis C.

The first through fourth lens assemblies L1, L2, L3, and L4, which perform zoom and focusing operations, are accommodated in the barrel case 150, which includes the first through third movement barrels 110, 120, and 130 and the fixed barrel 100.

Hereinafter, a driving operation of the first through fourth lens assemblies L1, L2, L3, and L4 will be described. The first through fourth lens assemblies L1, L2, L3, and L4 are sequentially disposed from a front side to a back side along the optical axis C. The lens assemblies L1, L2, L3, and L4 each include at least one optical lens and respectively include lens frames 10, 20, 30, and 40 for mounting the optical lens.

For example, the first and second lens assemblies L1 and L2 may be driven along the optical axis C according to a predetermined cam curve, and the third and fourth lens assemblies L3 and L4 may be driven along the optical axis C by a driving element (not shown). The first through third lens assemblies L1, L2, and L3 may perform a zooming operation for changing a focal distance, and the fourth lens assembly L4 may perform a focusing operation by being finely displaced along the optical axis C.

The third and fourth lens assemblies L3 and L4 may be independently driven by a driving element, e.g., a DC motor (not shown). For example, the third and fourth lens assemblies L3 and L4 may be gear-connected to the DC motor, and, by controlling a rotational amount of the DC motor according to an output signal of a sensor that may sense the rotational amount of the DC motor, positions of the third and fourth lens assemblies L3 and L4 along the optical axis C may be precisely controlled. A shutter I for adjusting an exposure time for the image sensor S by passing/blocking an optical path of a subject image may be disposed in the third lens assembly L3.

The first and second lens assemblies L1 and L2 are arranged in the second movement barrel 120 may be moved forward or backward on the optical axis C, and may be moved along the optical axis C according to a cam curve that is set in the second movement barrel 120. The first lens assembly L1 is the front end of the third movement barrel 130, and may be moved with the third movement barrel 130 along the optical axis C as a single body. A movement mechanism of the third movement barrel 130 has been described above.

The second lens assembly L2 may be moved along the optical axis C according to a cam curve set in the second movement barrel 120. A protrusion 25 is formed on an outer circumference of the second lens assembly L2, and a cam groove 120c to which the protrusion 25 may be coupled is formed on the inner circumference of the second movement barrel 120, and an amount that the second lens assembly L2 may move is determined according to the relationship between the protrusion 25 and the cam groove 120c. That is, while the protrusion 25 is coupled to the cam groove 120c, if the second barrel 120 is rotated, the protrusion 25 is moved along the cam groove 120c, and thus the second lens assembly L2 may be moved along the optical axis C.

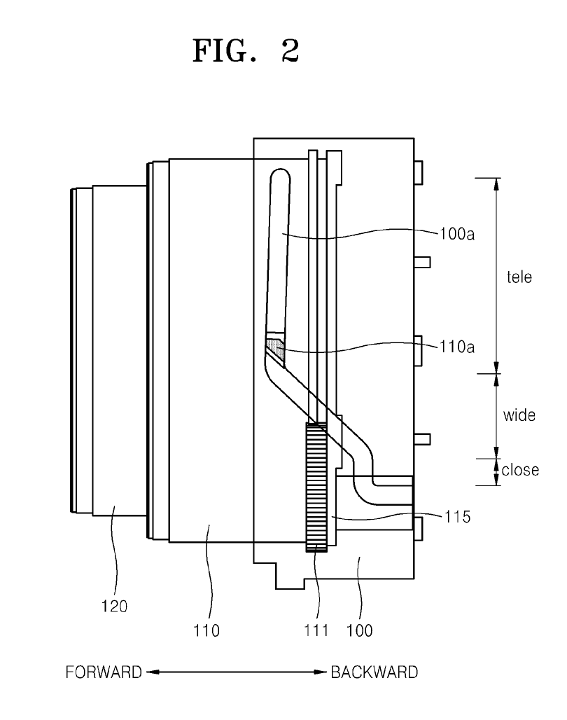

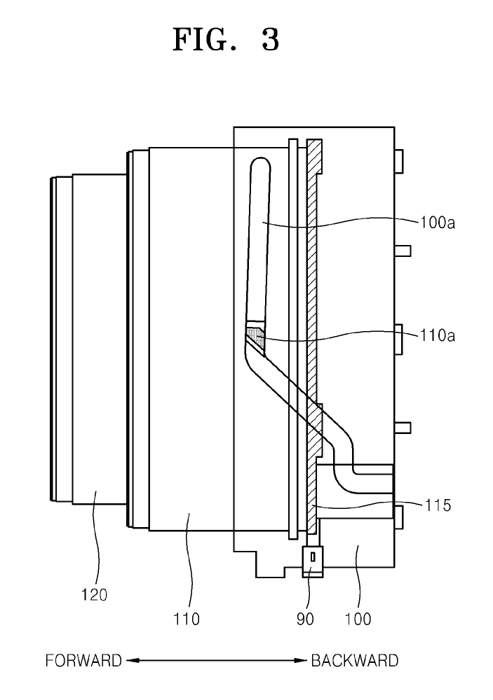

FIGS. 2 and 3 are side views of the lens barrel of FIG. 1 illustrating driving mechanisms of the first movement barrel 110. Referring to FIG. 2, a gear unit 111 is disposed on a rear surface of the first movement barrel 110, and the gear unit 111 is power-connected to a driving element (not shown). As rotational power provided by the driving element is transferred via the gear unit 111 to the first movement barrel 110, the first movement barrel 110 is rotationally driven. For example, the driving element may be a DC motor, and by inputting a controlled driving pulse to the DC motor, the rotation of the first movement barrel 110 may be controlled.

The protrusion 110a formed on the outer circumference of the first movement barrel 110 is coupled to the cam groove 100a of the fixed barrel 100. As the first movement barrel 110 is rotated, the protrusion 110a of the first movement barrel 110 is guided along the cam groove 100a on the fixed barrel 100, and as the protrusion 110a is moved along the cam groove 100a, the first movement barrel 110 may be moved back and forth along the optical axis C. The cam groove 100a has a tele section that may minutely displace a tele position of the first movement barrel 110 and a wide section in which the first movement barrel 110 may be moved backward on the optical axis C along approximately an oblique line from the tele section, and a close section in which the first movement barrel 110 is maintained at a back position.

Referring to FIG. 3, a portion of the straight guide member 115, which moves as a single unit with the first movement barrel 110 along the optical axis C, is exposed at the back of the first movement barrel 110. An optical axis direction position sensor 90 for sensing a position of the straight line guide member 115 along the optical axis C is disposed on the inner circumference of the fixed barrel 100 to be adjacent to the exposed portion of the straight guide member 115. The optical axis direction position sensor 90 is also for detecting a position of the first movement barrel 110 along the optical axis C, and the optical axis direction position sensor 90 may sense the position of the first movement barrel 110 directly or sense a position of the straight guide member 115, which moves as a single body with the movement barrel 110, as illustrated in FIG. 3.

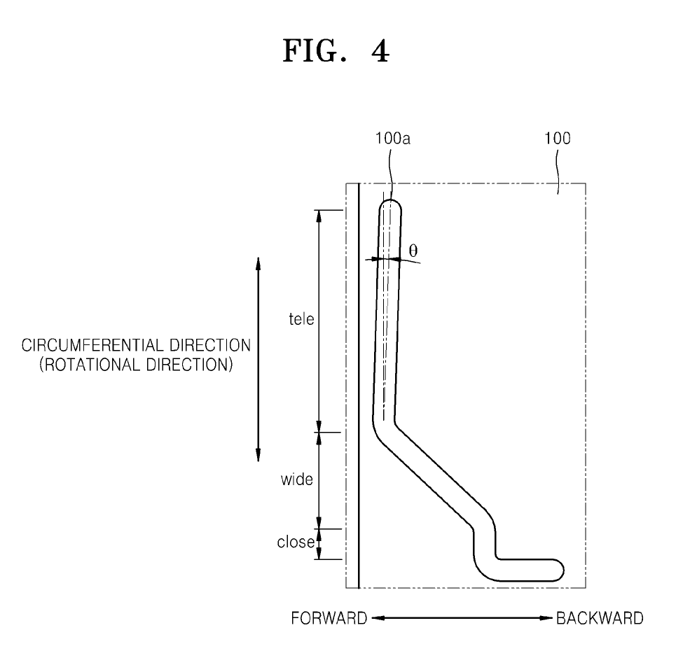

FIG. 4 is a development diagram illustrating an inner portion of the fixed barrel 100, wherein the cam groove 100a set in the fixed barrel 100 to guide the first movement barrel 110 is shown. The cam groove 100a includes the tele section, the wide section, and the close section, and guides the first movement barrel 110 along the optical axis C. The first movement barrel 110 may be in a mode for finely moving around a tele position according to the cam groove 100a (tele section), a mode for moving along a cam surface of an oblique line from the tele position to the back position, and a mode for maintaining the back position (close section).

According to an embodiment of the invention, the tele section of the cam groove 100a may be not parallel to a rotational direction (circumferential direction) of the first movement barrel 110 but may be formed along an oblique line inclined at a predetermined angle (θ). Accordingly, the first movement barrel 110 does not maintain a uniform position with respect to the optical axis C in the tele section, but may be finely moved back and forth on the optical axis C, for example. Accordingly, by detecting the position of the first movement barrel 110 along the optical axis C, a rotation position of the first movement barrel 110 may be accurately detected, and the optical lens may be precisely positioned at target positions by controlling the movement amount of the first movement barrel 110.

For example, since predetermined tolerances exist in a gear row (e.g., the gear unit 111 of FIG. 2) between the first movement barrel 110 and the driving element (DC motor) in order to avoid mechanical interference, exact gearing is not created and predetermined backlash may be generated. Accordingly, rotational inconsistencies between the driving element (DC motor), which is a unit that drives, and the first movement barrel 110, which is a unit that is driven, are generated, and a precise current rotation position of the first movement barrel 110 may not be detected even when the rotational state of the driving element (DC motor) is sensed. If position controlling of the optical lens is performed based on erroneous rotation positions of the first movement barrel 110, the precision in positioning the optical lens is decreased.

As illustrated in FIG. 4, when the tele section of the cam groove 100a is formed along the oblique line at a predetermined angle (θ), the first movement barrel 110 may move back and forth along an inclined surface of the cam groove 100a, and the position of the first movement barrel 110 along the optical axis C changes continuously according to the rotational amount of the first movement barrel 110. Consequently, by sensing the position of the first movement barrel 110 along the optical axis C, an exact rotation position of the first movement barrel 110 may be detected, and by controlling the rotational amount based on the exact rotation position, the optical lens may be moved to a target position exactly.

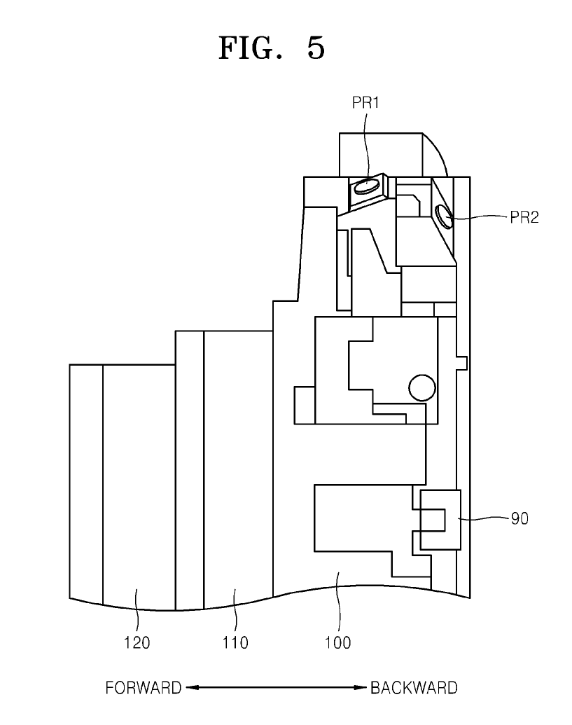

FIG. 5 illustrates an arrangement of a sensor for controlling positioning of the first movement barrel 110. Referring to FIG. 5, rotation position sensors PR1 and PR2 for detecting a rotation position of a driving element may be mounted near the driving element. The rotation position sensors PR1 and PR2 may each include a photo sensor and an encoder. For example, a plurality of detection pins (not shown) may be arranged on an axis of the driving element (e.g., a DC motor) supplying motive power, and a rotational state of the driving element may be sensed by using the photo sensors to sense movement of the detection pins and the encoders to count a rotation number.

The optical axis direction position sensor 90 for detecting the position of the first movement barrel 110 along the optical axis C is disposed on the fixed barrel 100. The optical axis direction position sensor 90 detects the position of the first movement barrel 110 or the position of the straight guide member 115, or both, which moves as a single body with the first movement barrel 110, to detect the rotational state of the first movement barrel 110.

The rotation position of the first movement barrel 110 may be detected from signals output by the rotation position sensors PR1 and PR2 and by the optical axis direction position sensor 90, and by controlling a rotational amount based on exact rotation positions, the optical lens may be positioned at a target position precisely. Although the optical axis direction position sensor 90 and the two rotation position sensors PR1 and PR2 are illustrated, the technical scope of the invention is not limited thereto. For example, only the optical axis direction position sensor 90 may be disposed, or the optical axis direction position sensor 90 and one rotation position sensor may be disposed.

According to the conventional art, at least two sensors are used to detect a rotational state of a driving element, but according to the embodiment of the present invention, the rotational state of the first movement barrel 110 may be detected exactly by only the optical axis direction position sensor 90, thereby reducing the number of sensors and easing manufacturing of the lens barrel to reduce costs.

The lens barrel is mounted in front of the camera body. The camera body includes the image sensor S (see FIG. 1) to convert a subject image, which is received through the lens assemblies L1, L2, L3, and L4, which perform a zooming operation of zooming on a subject and a focusing operation of focusing on the subject, into an electrical image signal, and may include circuits (not shown) for processing the image signal of the image sensor S and storing the same in an appropriate file format.

According to the lens barrel and the digital camera including the lens barrel of embodiments of the present invention, a cam groove that guides a movement barrel is designed in such a way that a position of the movement barrel along an optical axis changes continuously according to a rotational amount of the movement barrel. Accordingly, an exact rotation position may be detected by sensing the position of the movement barrel along the optical axis, and the optical lens may be moved exactly to a target position by controlling the rotational amount of the movement barrel based on the position of the movement barrel along the optical axis, thereby increasing precision of positioning.

All references, including publications, patent applications, and patents, cited herein are hereby incorporated by reference to the same extent as if each reference were individually and specifically indicated as incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components that perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

The words “mechanism” and “element” are used herein generally and are not limited solely to mechanical embodiments. Numerous modifications and adaptations will be readily apparent to those skilled in this art without departing from the spirit and scope of the present invention.

What is claimed is:

1. A lens barrel comprising:
a barrel case comprising a fixed barrel mounted to a camera body and a first movement barrel that is moveable along an optical axis according to a cam groove formed on an inner surface of the fixed barrel; and
a lens assembly accommodated in the barrel case,
wherein a tele section is a front portion of the cam groove and is oblique with respect to a rotational direction of the first movement barrel by a predetermined angle, wherein a front side is a side in a direction toward a subject.

2. The lens barrel of claim 1, wherein an optical axis direction position sensor for detecting a position of the first movement barrel along the optical axis is disposed on the fixed barrel.

3. The lens barrel of claim 1, wherein, when the cam groove is developed on a plane, the cam groove comprises:
the tele section in the front portion of the cam groove, a wide section that extends from the tele section along an oblique line, and a close section that extends from the wide section and is parallel to the rotational direction of the first movement barrel.

4. The lens barrel of claim 1, wherein the tele section comprises two ends referred to as first and second positions, respectively, wherein the first position contacts the wide section and is closer to the front side than the second position, which is away from the wide section.

5. The lens barrel of claim 1, comprising a straight guide member that is movable with the first movement barrel along the optical axis is disposed on an inner portion of the first movement barrel.

6. The lens barrel of claim 5, wherein an optical axis direction position sensor for detecting a position of the straight guide member along the optical axis is disposed on the fixed barrel.

7. The lens barrel of claim 5, further comprising a second movement barrel that is disposed inside the straight guide member, wherein the second movement barrel is movable along the optical axis according to a cam groove in the straight guide member.

8. The lens barrel of claim 1, further comprising a driving element that provides rotational power to the first movement barrel, wherein a rotation position sensor for detecting a rotational state of the driving element is disposed near the driving element.

9. The lens barrel of claim 1, wherein a protrusion that is coupled to the cam groove is formed on an outer circumference of the first movement barrel.

10. A digital camera comprising:
a camera body;
a barrel case comprising a fixed barrel mounted to a camera body and a first movement barrel that is moveable along an optical axis according to a cam groove formed on the fixed barrel; and
a lens assembly accommodated in the barrel case,
wherein a tele section is a front portion of the cam groove and is oblique with respect to a rotational direction of the first movement barrel by a predetermined angle, wherein a front side is a side in a direction toward a subject.

11. The digital camera of claim 10, wherein an optical axis direction position sensor for detecting a position of the first movement barrel along the optical axis is disposed on the fixed barrel.

12. The digital camera of claim 10, wherein, when the cam groove is developed on a plane, the cam groove comprises:
the tele section in the front portion of the cam groove, a wide section that extends from the tele section along an oblique line, and a close section that extends from the wide section and is parallel to the rotational direction of the first movement barrel.

13. The digital camera of claim 10, wherein the tele section comprises two ends referred to as first and second positions, respectively, and wherein the first position contacts the wide section and is closer to the front side than the second position which is away from the wide section.

14. The digital camera of claim 10, comprising a straight guide member that is movable with the first movement barrel along the optical axis is disposed on an inner portion of the first movement barrel.

15. The digital camera of claim 14, wherein an optical axis direction position sensor for detecting a position of the straight guide member along the optical axis is disposed on the fixed barrel.

16. The digital camera of claim 14, further comprising a second movement barrel that is disposed inside the straight guide member, wherein the second movement barrel is moved along the optical axis according to a cam groove in the straight guide member.

17. The digital camera of claim 10, further comprising a driving element that provides rotational power to the first movement barrel, wherein a rotation position sensor for detecting a rotational state of the driving element is disposed near the driving element.

18. The digital camera of claim 10, wherein a protrusion that is coupled to the cam groove is formed on an outer circumference of the first movement barrel.
